(19) United States
(12) Patent Application Publication
(10) Pub. No.: US 2009/0139121 A1
(43) Pub. Date: Jun. 4, 2009

(54) Promotional calendar and website

(76) Inventor: Thomas M. Bury, College Park, MD (US)

Correspondence Address: WILLIAM S RAMSEY, ESQ, 5253 EVEN STAR PLACE, COLUMBIA, MD, 21044, US

(21) Appl. No.: 12/321,748

(22) Filed: Jan. 23, 2009

Related U.S. Application Data
(63) Continuation-in-part of application No. 61/063,014, filed on Jan. 30, 2008.
Application No. 61/063,014 is a continuation-in-part of application No. 11/227,560, filed on Sep. 15, 2005, now abandoned.
Application No. 11/227,560 is a continuation-in-part of application No. 11/041,397, filed on Jan. 24, 2005.
Application No. 11/041,397 is a continuation-in-part of application No. 10/638,765, filed on Aug. 11, 2003, now abandoned.

(51) Int. Cl. B42D 5/06; G09D 3/00; G06Q 30/00

(52) U.S. Cl. 40/121; 40/107; 705/26

(57) ABSTRACT

An exemplary embodiment providing one or more improvements includes calendars for dissimulation by distributors of customizable promotion products with distributor specific URLs which enable the customer to view supplier produced products which then are ordered through the distributor. The distributor then reviews and forwards the order to the suppliers who then manufacture the customized items and either ship the items directly to the customer or ships the items to the distributor who checks the items and forwards them to the customer. A number of URLs may access the same website. The calendars also may include monthly themes, descriptions of the benefits of use of the themes, case studies and statistics involving use of the themes, promotional products, planning work sheets, and return on investment and return on objectives work sheets.

### CROSS-REFERENCES TO RELATED APPLICATIONS

Priority is claimed to provisional application No. 61/063,014, filed on Jan. 30, 2008, pending, which is a continuation-in-part of application Ser. No. 11/227,560, filed on Sep. 15, 2005, abandoned, which is a continuation-in-part of application Ser. No. 11/041,397, filed on Jan. 24, 2005, abandoned, which is a continuation-in-part of application Ser. No. 10/638, 765, filed on Aug. 11, 2003, abandoned.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### REFERENCE TO A “SEQUENCE LISTING,” A TABLE, OR A COMPUTER PROGRAM LISTING APPENDIX

Not Applicable.

### BACKGROUND.

### DESCRIPTION OF RELATED ART INCLUDING INFORMATION DISCLOSED UNDER 37 CFR 1.97 AND 37 CFR 1.98

The present application discloses embodiments of a calendar and system in which calendars provided by distributors to their customers both contain advertisements from suppliers for customizable promotional items of interest to the customers, who typically are retailers, and also contains a distributor specific website address. Neither the calendar nor the website contains accessible information which would allow the customer to order directly from the supplier but both the calendar and website contain symbols which allow the customer to inform the distributor of the desired order. The distributor then reviews and forwards the order to the suppliers who then manufacture the customized items and either ships the items directly to the customer or ships the items to the distributor who checks the items and forwards them to the customer.

U.S. Pat. No. 2,128,989 discloses a booklet calendar suitable for mailing with advertising visible throughout the life of the calendar.

U.S. Pat. No. 2,228,517 discloses a calendar display in which a calendar month card is presented with a picture suitable to the season, the pictures located on the back of calendar cards other than that card for the current month.

U.S. Pat. No. 3,605,306 discloses a self-mailing calendar in which a portion of the back cover extending from below the calendar pages is used to seal the folded calendar and subsequently to provide a pencil holder when the calendar is opened.

U.S. Pat. No. 4,798,402 discloses a hanging calendar in which the current month is at the top, there is a space for notations and priorities, and the following month is at the bottom. When the current month is over the calendar is folded so the previously following month is now at the top and a new month is a following month.

U.S. Pat. No. 5,016,917 discloses a regimen calendar which correlates time periods and a predetermined regimen such as a diet program.

U.S. Pat. No. 5,090,733 discloses a calendar in which each day is associated with either a label of either an “action” for the day or a “thought” for the day. Movement of the labels disclose illustrations on the calendar.

U.S. Pat. No. 5,106,122 discloses a combination calendar and catalog in which each month has a theme and tabs at the bottom of the calendar open to a portion of the catalog with products relating to the theme.

U.S. Pat. No. 5,316,342 discloses a calendar with symbols for events which occur within the month represented and an artwork field for decoration by an art student.

U.S. Pat. No. 5,697,647 discloses an appointment calendar for a hairstylist having index tabs for the months and double pages for each day of a month with rows and columns defining areas for entry of data concerning clients.

U.S. Pat. No. 5,799,423 discloses a magnetic perpetual calendar in which indicia indicating the month and date and information specific to particular days are printed on magnetic strips which adhere to the calendar when it is in place on a ferromagnetic surface.

U.S. Pat. No. 6,138,391 discloses a calendar with monthly calendars and a top cover having separate apertures for viewing the monthly calendar month and each day of the month indicia.

U.S. Pat. No. 6,186,553 discloses a theme calendar in which personalized calendars are designed and generated by a computer system.

U.S. Pat. No. 6,536,965 discloses a calendar selling system with a plurality of pictures which are selected by a customer who orders a printed calendar.

U.S. Pub. Pat. Applic. 2001/0042011 discloses an electronic version of an advent calendar in which selected doors are opened and the viewer is invited to select a treat or gift which can be hyperlinked to an URL with such items for sale.

U.S. Pub. Pat. Applic. 2001/0051901 discloses a shopping tool linking consumers to retailer pricing and database information.

U.S. Pub. Pat. Applic. 2002/0052775 discloses a method and software for implementing a multi-activity marketing plan.

U.S. Pub. Pat. Applic. 2002/0114220 discloses a calendar for distribution by service providers which shows dates just beyond the period generally recommended for repetition of the service provided.

U.S. Pub. Pat. Applic. 2005/0120598, corresponding to Ser. No. 11/041,397, incorporated herein by reference, discloses a calendar for distribution to customers by distributors, with advertisements of suppliers which do not allow direct contact of the suppliers by the customers.

U.S. Pub. Pat. Applic. 2006/0010036, corresponding to Ser. No. 11/227/560, incorporated herein by reference, discloses a website associated with distributors, with advertisements of suppliers which do not allow direct contact of the suppliers by the customers.

U.S. Pub. Pat. Applic. 2007/0050247 discloses an advertising calendar with a place for the customer to write on and advertisements.

The foregoing examples of the related art and limitations related therewith are intended to be illustrative and not exclusive. Other limitations of the related art will become apparent to those of skill in the art upon a reading of the specification and a study of the drawings.

### BRIEF SUMMARY

The following embodiments and aspects thereof are described and illustrated in conjunction with systems, tool and methods which are meant to be exemplary and illustrative, not limiting in scope. In various embodiments, one or more of the above-described problems have been reduced or eliminated, while other embodiments are directed to other improvements.

Embodiments include a calendar for dissemination by distributors of customized promotional products manufactured by suppliers to customers of such products. Embodiments include a calendar with accessible information indicia on the calendar allowing access to the distributor by the customer, and a distributor specific URL indicia bearing distinctive identification indicia concerning the distributor. The URL indicia is for a password-protected website homepage bearing distinctive identification indicia concerning the distributor. The website further comprises a multiplicity of supplier advertising pages bearing information indicia concerning customized promotional products, each website supplier advertising page being free of accessible information indicia allowing contact between customers and suppliers. Each website supplier advertising page further bears identifying symbol indicia such as ASI code number which allows identification of the supplier by the distributor, wherein a multiplicity of distributor specific website homepages lead to the same supplier advertising pages.

Embodiments include the process of selecting, ordering, and manufacturing customized promotional products for customers by distributors and suppliers which comprises the following steps. a. providing a customer with a calendar bearing a distributor's website address by a distributor, b. accessing the distributor's website by the customer, c. perusing the product's on supplier advertising pages free of accessible information allowing contact between customers and suppliers by the customer, d. ordering selected customized promotional products from the distributor by the customer using identifying symbols allowing identification of the supplier by the distributor, e. ordering the selected customized promotional products from the suppliers by the distributor, f. manufacturing the selected customized promotional products by the supplier, and g. providing the customer the selected customized promotional products.

In addition to the exemplary aspects and embodiments described above, further aspects and embodiments will become apparent by reference to the drawings and by study of the following descriptions.

### BRIEF DESCRIPTION OF THE DRAWINGS

FIG. 1 is a diagrammatic representation of the steps in an embodiment process of obtaining customized promotional products by customers using a calendar alone or a calendar and the internet.

FIG. 2 is a view of the cover of an embodiment calendar in the closed position

FIG. 3 is a view of the header side of the cover (FIG. 2) of an embodiment calendar in the open position showing a page describing use of the calendar.

FIG. 4 is a view of a grid page of an embodiment calendar in the open position showing a monthly page.

FIG. 5 is a view of the header side of a grid page (FIG. 4) of an embodiment calendar in the open position showing a monthly theme, tips for implementation of the theme, and several promotional produces to reinforce the theme.

FIG. 6 is a view of a grid page of an embodiment calendar in the open position showing the days of a month, a promotional showcase product, the four products associated with the month, and early ordering warning.

FIG. 7 is a view of the header side of a grid page (FIG. 6) of an embodiment calendar in the open position showing planning tools and a two year calendar.

FIG. 8 is a view of a tear-out grid page of an embodiment calendar in the open position showing a planning page for use of a distributor working with a customer.

FIG. 9 is a view of the header side of a grid page (FIG. 8) of an embodiment calendar in the open position showing descriptive matter concerning a marketing assessment.

FIG. 10 is a view of the inside back cover of an embodiment calendar in the open position showing a planning page for use of a customer working with a distributor and having an extended contact flap bearing accessible information concerning the distributor

FIG. 11 is a view of the back cover of an embodiment calendar in the closed position showing a promotional showcase with further information concerning the 12 promotional items of the preceding 12 monthly pages.

FIG. 12 is a diagrammatic representation of the steps in an embodiment process of obtaining ordering information by customers using the internet and a password obtained from an embodiment calendar.

FIG. 13 is an embodiment internet Website Home Page.

FIG. 14 is an embodiment internet website Distributor Home Page.

FIG. 15 is an embodiment internet website Monthly Page.

FIG. 16 is an embodiment internet Featured Product Page.

FIG. 17 is an embodiment internet Product Query Form page.

FIG. 18 is an embodiment internet Product Query Confirmation Page.

FIG. 19 is an embodiment internet Supplier Page.

FIG. 20 is an embodiment internet supplier Catalog Request Page.

FIG. 21 is an embodiment internet supplier Catalog Request Confirmation Page.

FIG. 22 is an embodiment internet Product Detail Page.

### DETAILED DESCRIPTION

Embodiments deal with the selection, manufacture and distribution of customized promotional products. They include presentation of calendars customized with the name and accessible information of a distributor to a customer. The customer then uses the information included on the calendar to select customizable products for the customer's use in promoting the customer's business. The customer may order customized products directly from the distributor or from the distributor after obtaining additional information on the products from the distributor's internet homepage. Both the calendar and website contain information allowing contact with the distributor but do not contain information allowing direct contact with the supplier by the customer.

In this disclosure the term “customized promotional product”, “promotional product”, “promotional item” or “product” means items which are embossed or decorated with names, logos, or other information concerning a business and are customarily provided gratis or for a nominal fee to patrons of that business. Examples of customized promotional products include pens, letter openers, balloons, etc. which are customized with the customer's identification information, such as name, logo, address, telephone, fax, and e-mail numbers, and website addresses. The term “customer” means a businessperson who orders and provides customized promotional products to present or prospective patrons of his or her business.

The term “supplier” means a person who manufactures or customizes the products ordered by a customer. The term “distributor” means a person who is an intermediary agent between a customer and supplier of customized promotional products, who provides information concerning the products, obtains and audits orders from the customer for customized promotional products, conveys such orders to suppliers, and optionally audits and delivers the finished customized promotional products to the customer. The term “consultant” means a person who represents a distributor in dealing with customers. The term “user” means the person who receives a customized promotional product from a customer. The term “accessible information” means information allowing contact between the customer and distributor, such as business name, contact, address, telephone or fax numbers, email or website addresses. The term “inaccessible information” and “identifying symbols” means information designating the supplier but not allowing direct access between the customer and supplier, such as supplier line name, symbols such as UPIC: HAMP002 or ASI# 219009 numbers. The distributor can contact a supplier using inaccessible information because the distributor can obtain accessible information using inaccessible information on the supplier.

In this disclosure the term “restricted constituency” means an organization restricted to suppliers and distributors in a single industry. Suppliers and distributors who are members of a restricted constituency can use inaccessible information or identifying symbols to communicate directly with each other. The general public and customers cannot use inaccessible information or identifying symbols to communicate directly with or to order directly from suppliers.

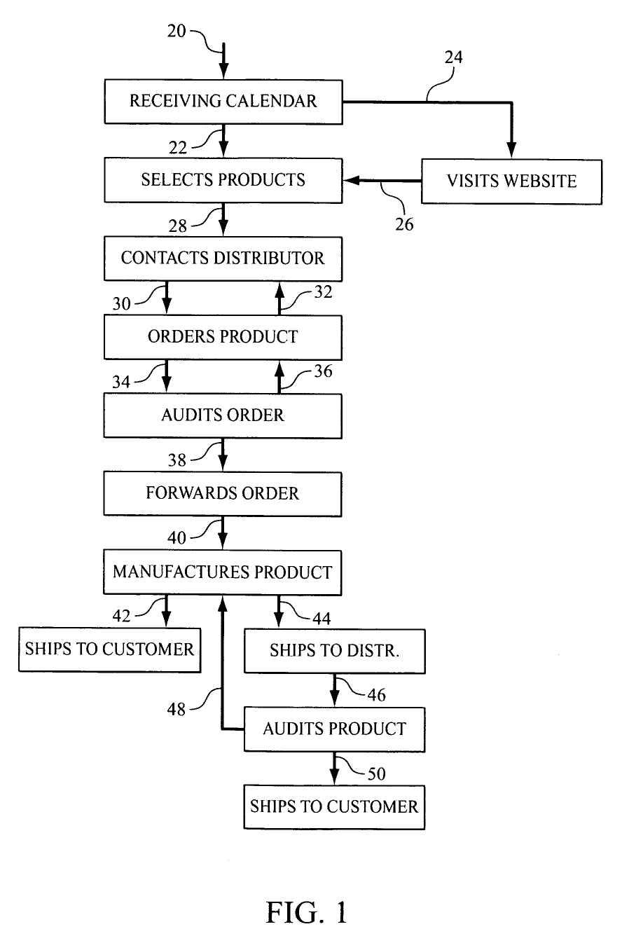

FIG. 1 is a diagrammatic representation of the steps in an embodiment process of obtaining customized promotional products by customers using a calendar alone or a calendar and the internet. In step 20 a distributor provides a customer with an embodiment calendar. The customer selects a product of interest directly from the calendar, step 22; or uses the password from the calendar to access information on the website, step 24, where the customer makes a selection of a product of interest, step 26. The customer then contacts the distributor for additional ordering information concerning price, delivery, product details, using accessible information from the calendar or website concerning the distributor, and inaccessible information concerning the supplier, step 30. The distributor provides the customer information on price, delivery, customization options, etc. in step 32 and receives a complete order from the customer in step 34. After auditing the order for completeness, step 38, the distributor forwards the order to the supplier, step 40.

The supplier manufactures the product and ships the product directly to the customer, step 42. Optionally, the supplier manufactures the product and ships the product to the distributor, step 44. The distributor checks and audits the shipment in step 46. If the product is suitable the distributor ships product to the customer 50. If the product is not suitable the distributor notifies the manufacture of the defects in step 48 and the cycle of auditing and shipping by the distributor is repeated.

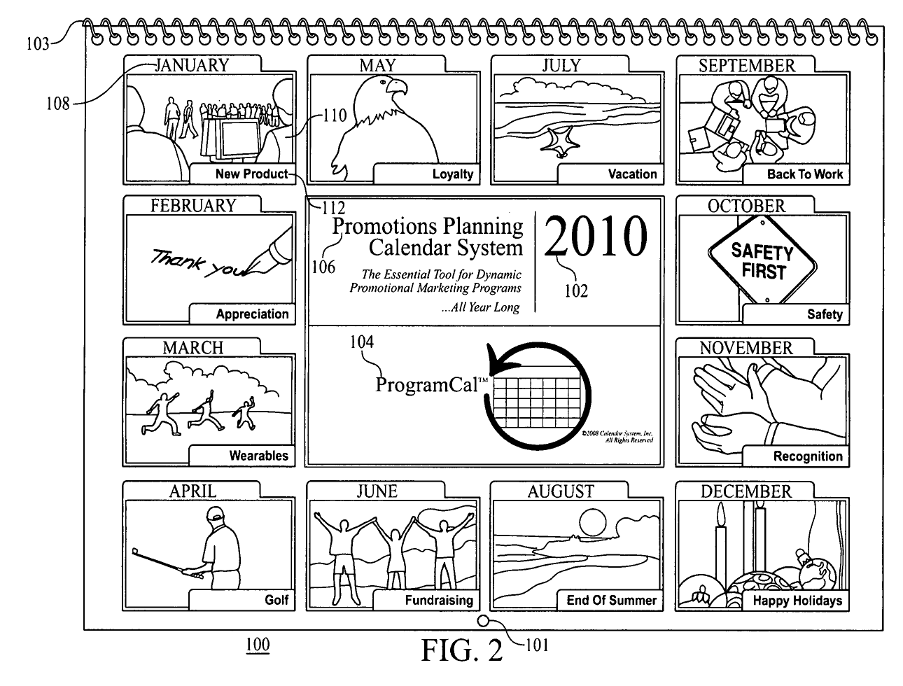

FIG. 2 is a view of the cover 100 of an embodiment calendar in the closed position. Visible in FIG. 2 is the bound side which in this embodiment is a spiral binder 103, but may be a stapled or sewn fold and a hanging hole 101 for attaching the calendar by a hook or nail on a wall when the calendar is in the open position. The cover 100 is not visible when the calendar is open and attached to a wall. A page which like the cover is visible with the binder 103 at the top of the page and a hanging hole 101 at the bottom of the page is termed a “grid” page. Also visible in FIG. 2 are twelve monthly representations, an example of which is January which contains the name of the month 108, a pictorial representation of the month 110, and the theme of the month 112. Also visible is the logo of the calendar manufacturer 104, the year 102, and a slogan 106.

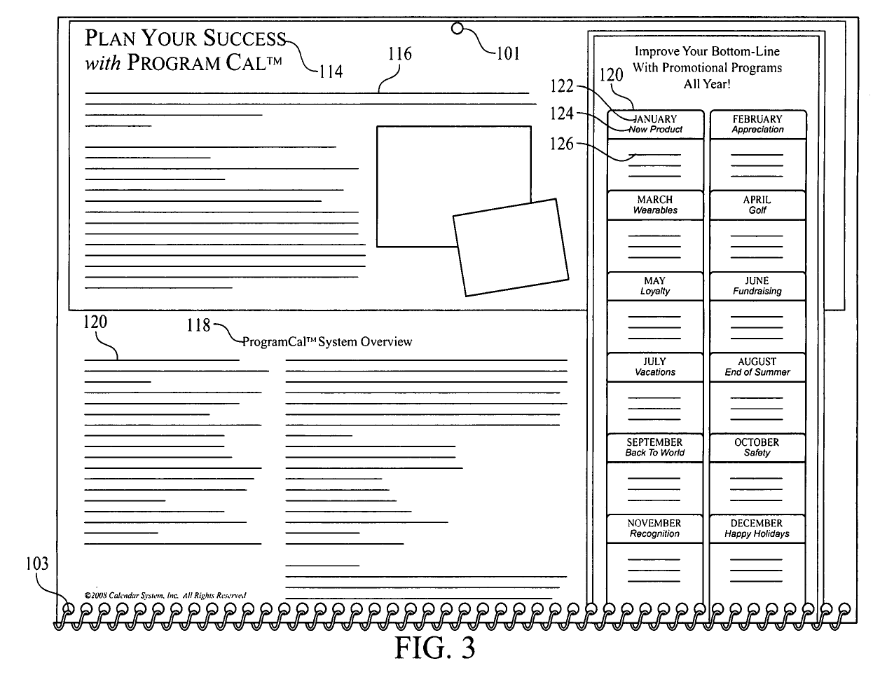

FIG. 3 is a view of the header side of the cover (FIG. 2) or grid page of an embodiment calendar in the open position, showing a page describing use of the calendar 114. Also visible is the binder 103 and the hanging hole 101. The purpose of the calendar is described 116. An overview of the system 118 includes writing describing worksheets, marketing assessments, The Marketing Minute, The Last Minute Alert, and the use and address of the calendar manufacturer's website. The promotional programs for the year are listed by month 120. Each monthly square includes the month 122, the theme 124, and writing describing the results to be expected through implementation of the theme 126.

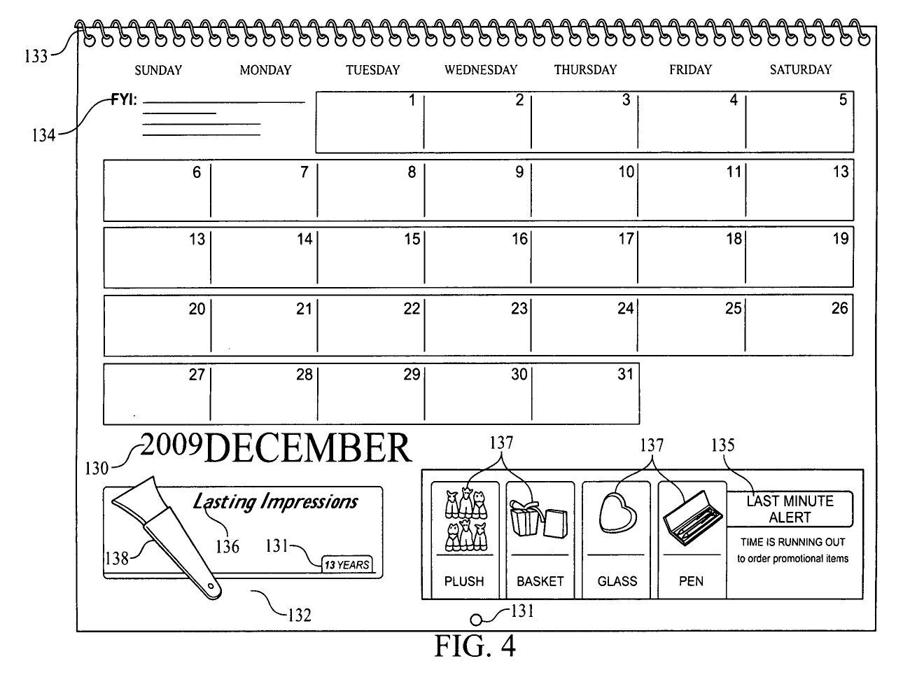

FIG. 4 is a view of a grid page 132 showing a conventional depiction of the month of December of the previous year 130. Also visible is the binder 133 and hanging hole 103. A FYI (for your information) box 134 has writing providing information concerning the use of promotional products. A Lasting Impression box 136 shows a successful promotional product 138, in this example, an ice scraper, which has endured for a period of years 131. A Last Minute Alert box 135 includes promotional product suggestions 137 to be ordered now for use in subsequent months 136.

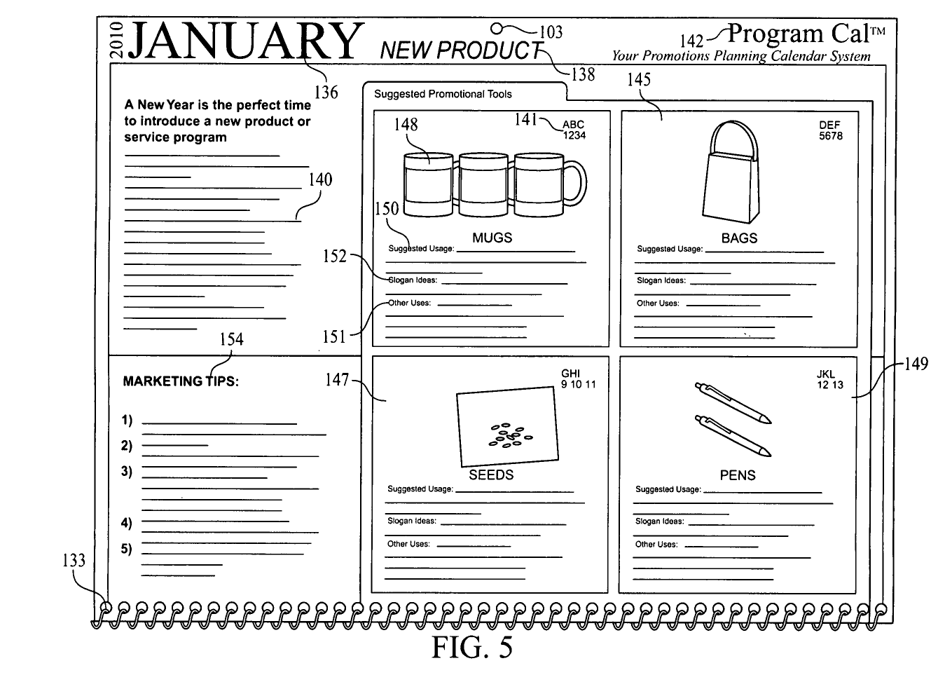

FIG. 5 is a view of the header side of a grid page (FIG. 4) of an embodiment calendar in the open position showing a monthly theme 138, in this case for January 2010 136, tips for implementation of the theme 154 (See Table 3), and four promotional produces that reinforce the theme 143, 145, 147, 149. The benefits 140 of applying the theme are listed. A reference to the website 142 is also included. One promotional product box 143 is shown in detail with a picture 148 of the product, a case study of use of the product 150, and a suggested slogan for use with the product 152 (See Table 4), and other suggested uses for recipients of the product 151. Codes which designate the product supplier are shown 141. Also visible is the binder 133 and the hanging hole 131.

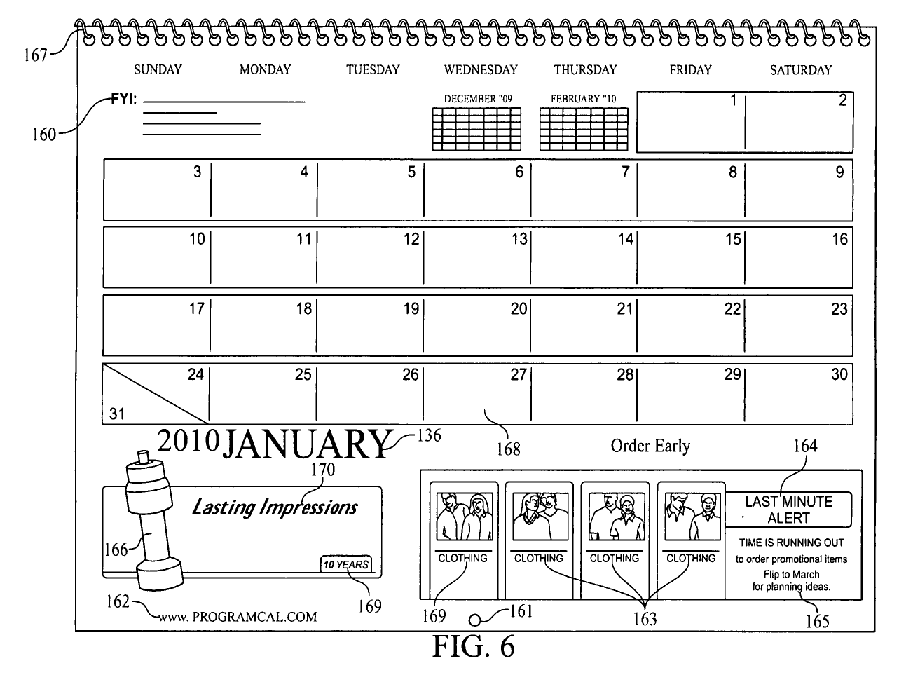

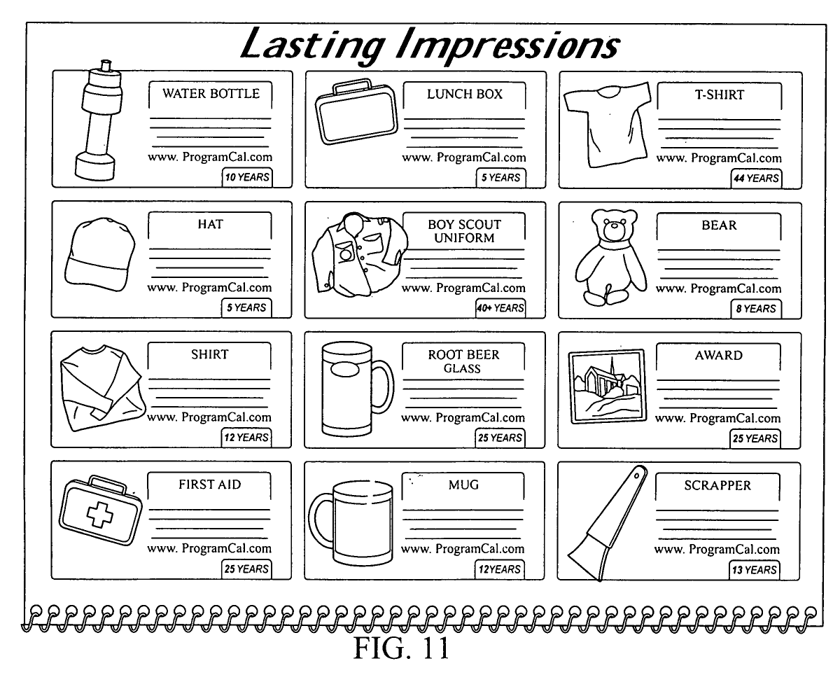

FIG. 6 is a view of a grid page which faces FIG. 5 of an embodiment calendar in the open position showing the days of a month, a promotional showcase product, the four products associated with the month, and early ordering warning. Also visible is the binder 167 and the hanging hole 161. The month and year 136 is shown with a calendar grid 168 representing the days of the month, as well a Last Minute Alert box 164 includes promotional product suggestions 163 for use in subsequent months 165. A FYI box 160 has information concerning uses of promotional products. the use of an internet webpage 162, The image 166 of a promotional product which has achieved the status of a multi-year keepsake in the mind of a user and the duration in years of its success 169 is in a Lasting Impressions box 170. More information on the Lasting Impressions is on the outside back cover (FIG. 11).

FIGS. 5 and 6 represent pages for the month of January which are visible at the same time when the calendar is fastened to the wall in the open position. Additional similar pages which present the themes (see Table 1) and associated products and associated benefits, as well as Lasting Impression products for each of the months of the year following January are part of embodiments but are not shown in the figures.

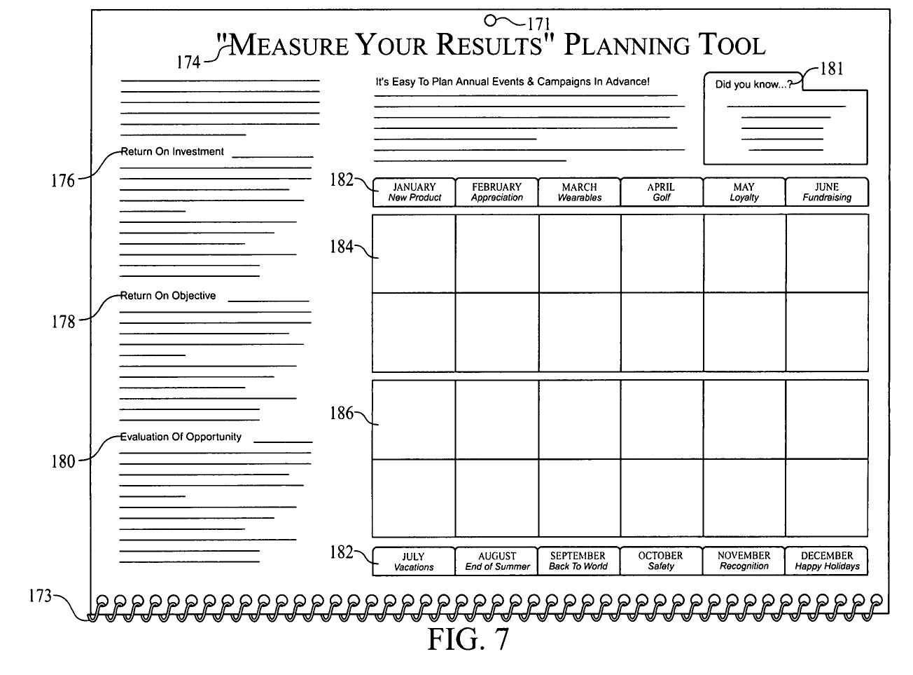

FIG. 7 is a view of the header side of a grid page of an embodiment calendar in the open position showing planning tools and a two year calendar. Also visible is the binder 173 and the hanging hole 171. To facilitate the use of the planning tools, a condensed current year 184 and next future year 186 calendars are included in FIG. 7. The How To Measure Your Results Page 174 include detailed instructions for determining Return on Investment (ROI) 176, Return on Opportunity (REO) 178 and Evaluation of Opportunity (EOO) 180 for use of the customer in planning marketing programs involving promotional products (See Table 2). Additional information on such calculations is shown in Table 2. In addition, colored icons 182 with names of the months and reminders of the themes of the months are included to assist the customer in making planning calculations. A Did You Know box 181 provides information on the value of planning.

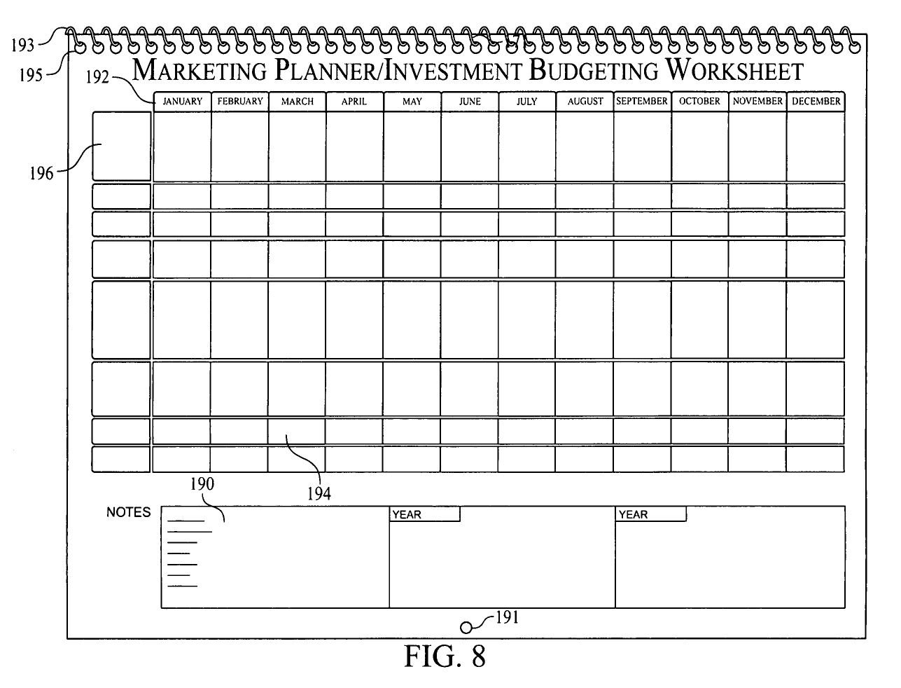

FIG. 8 is a view of a tear-out grid page of an embodiment calendar in the open position showing a Marketing Planner/Investment Budgeting Worksheet for use by a distributor consultant working with a customer. Also visible is the binder 193 and the hanging hole 191. A grid 194 is provided with months at the top 192 and planning items 196 arrayed vertically along one vertical axis for use in generating a promotional product marketing program by a distributor consultant along with a customer. There also is space 190 for notes for crucial events and client contact information. This page is designed for removal from the calendar and retention by the consultant and has provisions for disrupting the page for tear off 195, in this example a line of small holes in the paper used in conjunction with the binder. Other means for facilitating tear off are contemplated, such as a line of embossed cuts in the paper.

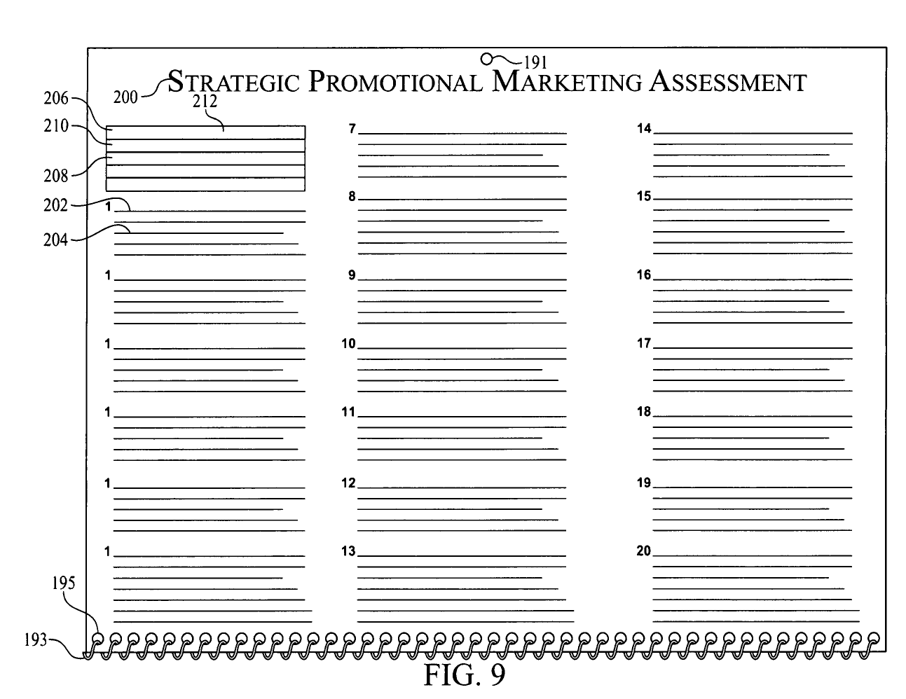

FIG. 9 is a view of the header side of a grid page (FIG. 8) of an embodiment calendar in the open position showing descriptive matter concerning a marketing assessment. Also visible is the binder 193, the hanging hole 191, and the tear off provisions 195. The Strategic Promotional Marketing Assessment 200 has provisions for the date 206 of the meeting between a consultant and customer, as well as recording the name of the customer's company 208, contact person at the customer's company 210, and follow up date 212 for additional meetings between consultant and customer. Specific questions 202 concerning a marketing campaign are provided as well as space 204 recording the answers. The customer answers the questions in preparation for an interview with a distributor's representative consultant The sheet which includes both FIG. 8 and FIG. 9 is designed for removal by a consultant after an interview with a customer.

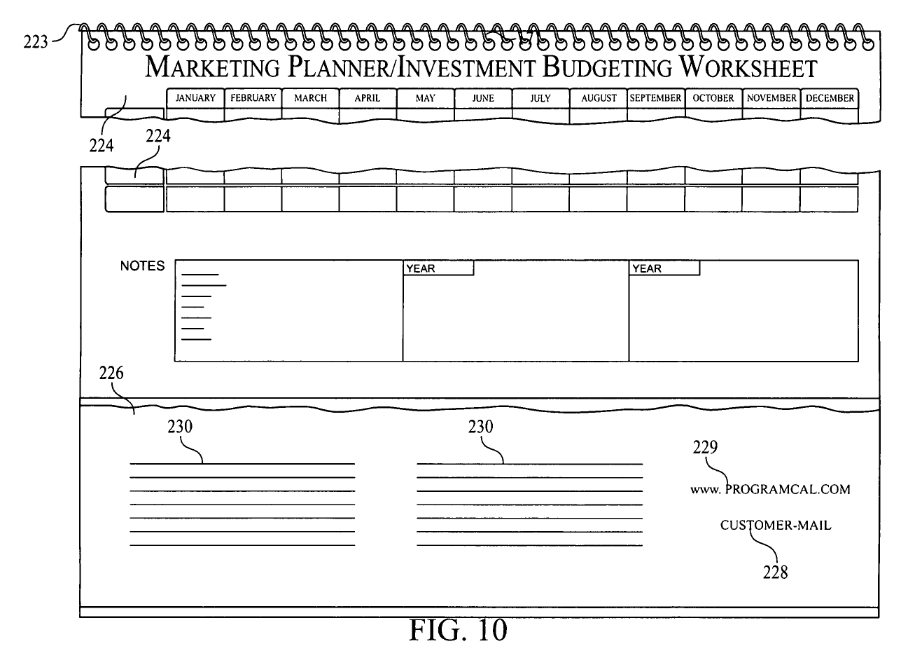

FIG. 10 is a view of the inside back cover of an embodiment calendar in the open position showing a planning page 224 for use of a customer working with a distributor consultant and having an extended contact flap 226 bearing accessible information concerning the distributor. The planning page 224, partially shown in FIG. 10, is identical to the distributor's consultant worksheet in FIG. 8. It provides the customer with a permanent copy of the plan developed in conjunction with the distributor's consultant. Also visible is the binder 223 and the extended flap 226 which is visible whenever the calendar is open and hanging on a wall. The extended flap 226 contains accessible information 230 concerning the distributor. There also is information 228 to be used as a password in accessing the calendar manufacturer's website. In the example in FIG. 10 the password is the distributor's email address, but other passwords also associated with the distributor are contemplated and may be used. FIG. 10 is intended to be filled out by the customer in conjunction with an interview with a consultant who represents the distributor in planning the customer's marketing campaign and provides the customer with a record of the campaign plan.

FIG. 11 is a view of the back cover of an embodiment calendar showing a “Lasting Impressions” 244 promotional showcase with further information concerning the 12 promotional showcase items of the preceding 12 monthly pages. Visible in FIG. 11 is the binder 223. For each monthly showcase item 242 there is the name of the item 246, and additional descriptive material 244 which describes the interest of a recipient in a promotional product which has caused that recipient to retain the product for a multi-year period 250. In general, the showcase products have an aspect which resonates with and causes an emotional response in the recipient. There also is the website address 248 of a video describing the item.

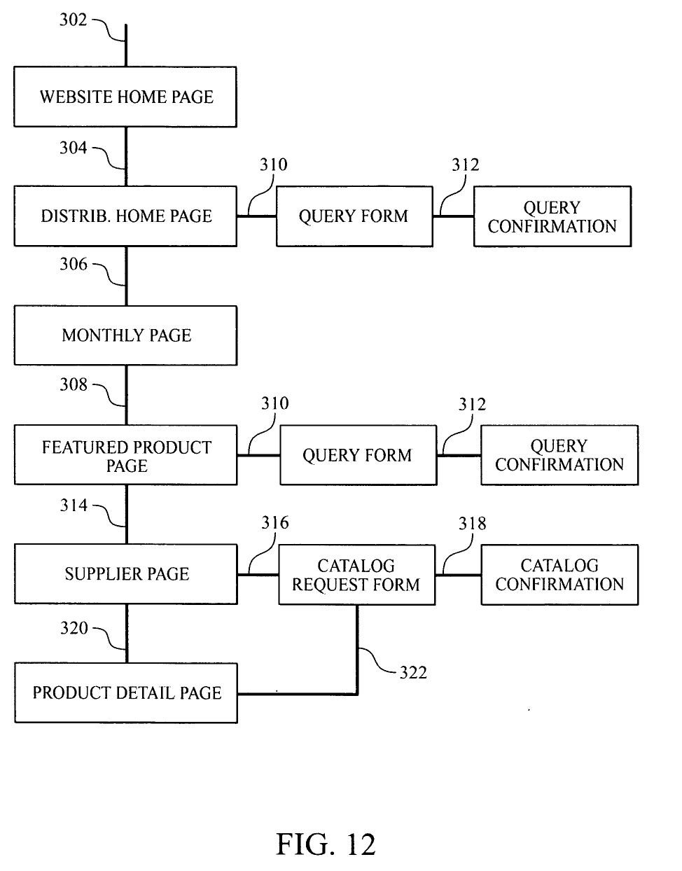

FIG. 12 is a diagrammatic representation of the steps in an embodiment process of obtaining ordering information by customers using the internet and a password obtained from an embodiment calendar. It should be noted that a customer is not able to order promotional products using the process of FIG. 12 but must order the products from the distributor. In FIG. 12, the action of a customer is indicated by reference numbers and the relevant web screen is indicated by the name of the screen within a rectangular box.

In step 302 the customer accesses the calendar manufacturer's website using the website address on the calendar (228 in FIG. 10) or through other sources, such as a search engine.

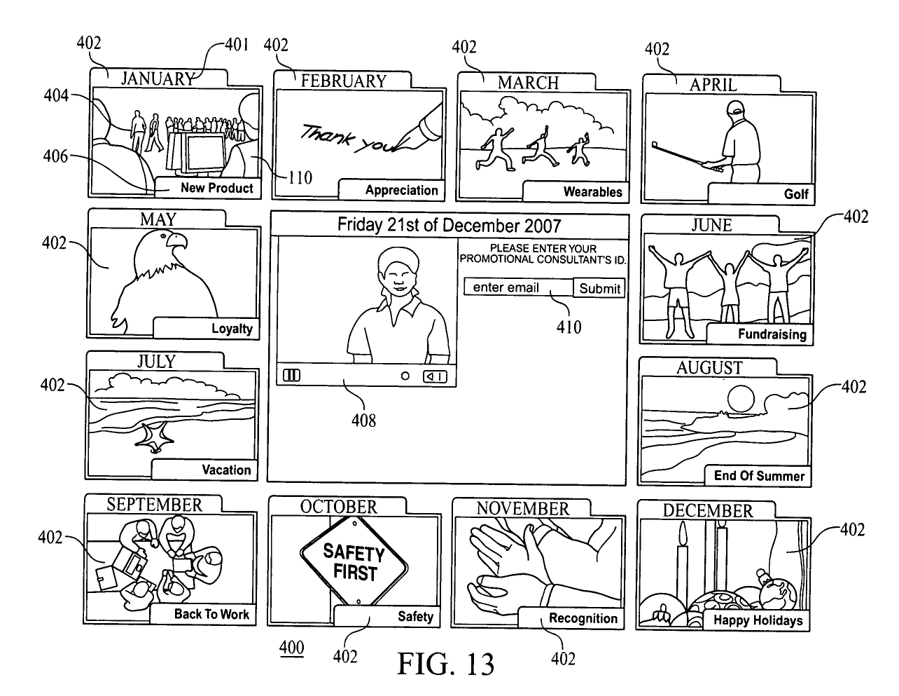

FIG. 13 depicts one embodiment internet website Calendar Manufacturer's Home Page 420. Visible in FIG. 13 are 12 boxes 402 each of which indicates a month of the year and includes a symbol of that month and the theme or program of that month. For example, in the first box January 401 is the name of the month represented, a calendar picture 404 symbolically depicts the month, and the theme or program 406 “NEW YEAR” is indicated. In addition, a video which may depict an actual person or an atavar presents a welcoming video 408 when clicked upon by the customer and also presents instructions to enter the password and click on the “SUBMIT” button.

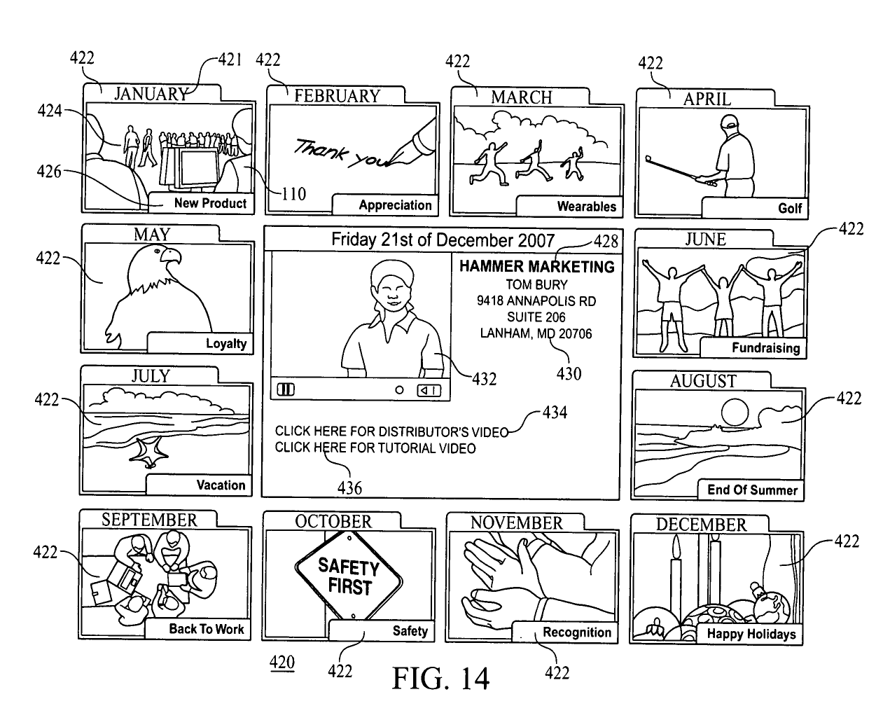

In step 304 the customer enters the password and clicks on the “SUBMIT “button. The password can be any suitable word or number or letters, in the embodiment depicted in FIG. 13 the Password is the distributor's website address which is listed at the bottom of the calendar hang page (230 in FIG. 10). This leads to the Distributor's Home Page, FIG. 14.

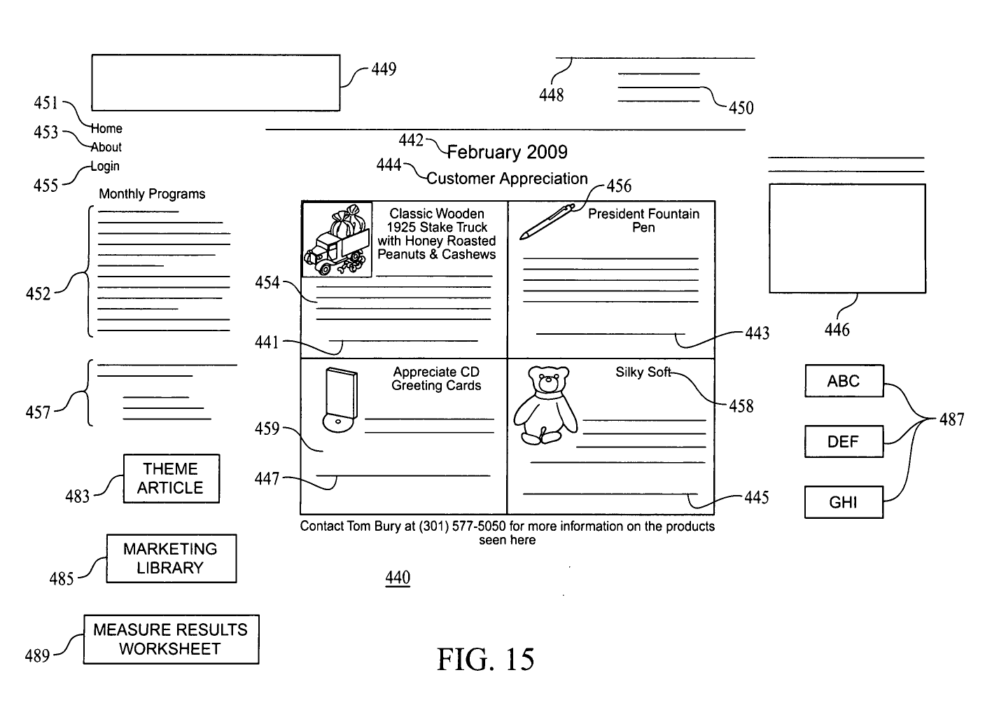

FIG. 14 is an embodiment internet website distributor homepage 420. This page contains the 12 monthly boxes 422 each of which indicates a month of the year at and includes a symbol of that month and the theme or program of that month. For example, in the first box January 421 is the name of the month represented, a calendar picture 424 symbolically depicts the month, and the theme or program 426 “NEW YEAR” is indicated. Clicking on one of the monthly boxes 422 leads to a monthly page an example of which is at FIG. 15. Also depicted in FIG. 14 is a video 432 which is accessed by either clicking on 434 which provides a video with information concerning the distributor, or by clicking on 436 which provides a video with a tutorial on information on using the website. Also visible in FIG. 14 is the distributor's name 428 and accessible information 430 which provides a number of channels for contact of the distributor by the customer. For example, clicking anywhere on box FEBRUARY 423 leads to the FEBRUARY Monthly Page FIG. 15.

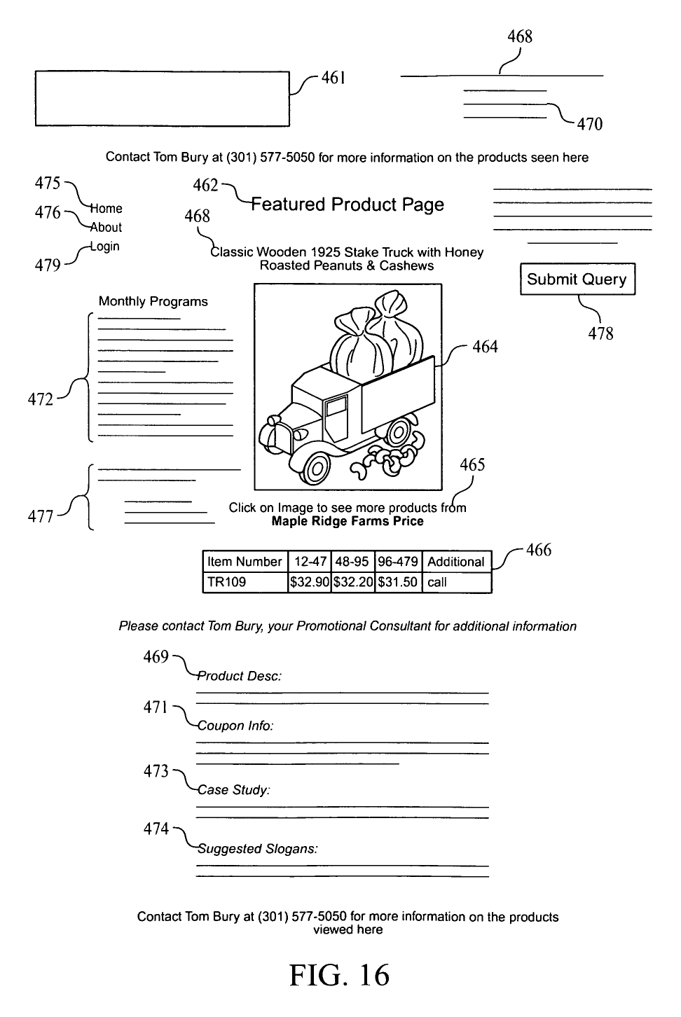

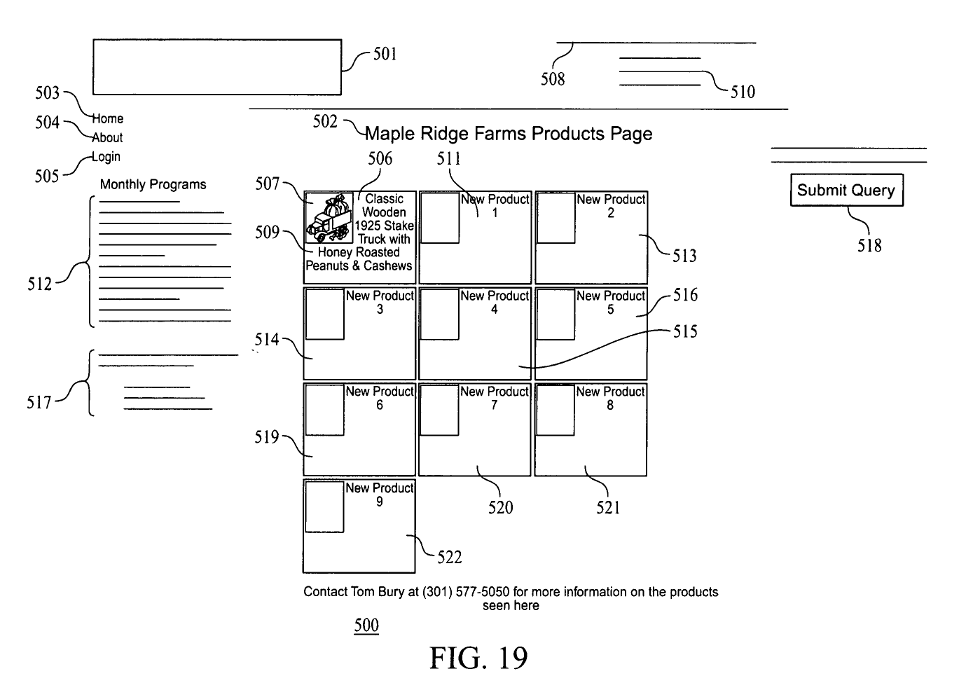

FIG. 15 is an embodiment internet website Monthly Page 440. Visible in FIG. 16 is the month name 442, and the theme or program 444 of the month. Four featured product boxes 454, 456, 458, and 459 are in the monthly page along with the name, picture, and short written description of the product in each box. A click here 441, 443, 445, and 447, respectively, leads to a featured product page. Accessible information including the distributor's name 448, address and phone number 450 is listed, along with the distributor's logo 449. Clicking on a video symbol 446 leads to a video about the benefits of a promotional program based on the theme of the month. Optionally, the featured products correspond to those found on the calendar on the corresponding month page. Clicking on “Home” 451 brings up the Calendar Manufacturer's Home Page (FIG. 13). Clicking on “About” 453 brings up information concerning the distributor. Clicking on “Login” 455 brings up the homepage. A list of the months and themes or programs 452 is arrayed along one side of the page. Clicking on any of the months listed leads to the appropriate monthly page. A forward looking reminder 457 reminds customers of the need to order products for use in upcoming months. Clicking on the Theme Article box 483 brings up a 500-800 word article on the monthly theme or product. Clicking on the Marketing Library box 485 brings up a library of 20 or more articles on marketing subjects in general. Clicking on the supplier logos 487 brings up the appropriate supplier page such as FIG. 19. Clicking on Measure Results Worksheet box 489 leads to a website with a complete worksheet which explains more about ROI, ROO and EOO and provides specific examples of each tool.

In step 308 the customer clicks on one of the featured product boxes 454, 456, 458, or 459 in FIG. 16 which leads to FIG. 16, the Featured Product Page.

FIG. 16 is an embodiment internet featured product page 460. The name of the page 462 along with name of the featured product is listed along with a picture 464 of the featured product. Visible in FIG. 16 is the distributor logo 461, distributor name 468, and accessible information concerning the distributor 470. Clicking on “Home” 475 brings up the Calendar Manufacturer's Home Page (FIG. 13). Clicking on “About” 476 brings up additional information on the distributor. Clicking on “Login” 479 brings up the home page. A list of the months and themes or programs 472 is arrayed along one side of the page. Clicking on any of the months listed leads to the appropriate monthly page. A forward looking reminder 477 reminds customers of the need to order products for use in upcoming months. Inaccessible information 465 concerning the supplier, in this case, the supplier name is listed. Pricing information 466 is included, along with additional product description 469, coupon information 471, if applicable, a case study 473 showing the successful application of the product in application of the program, and suggested slogans 474 which tie the featured product with a desirable attribute of the customer's products or services are also included (See Table 4). For more information involving the featured product, the customer clicks a “Submit Query” box 478.

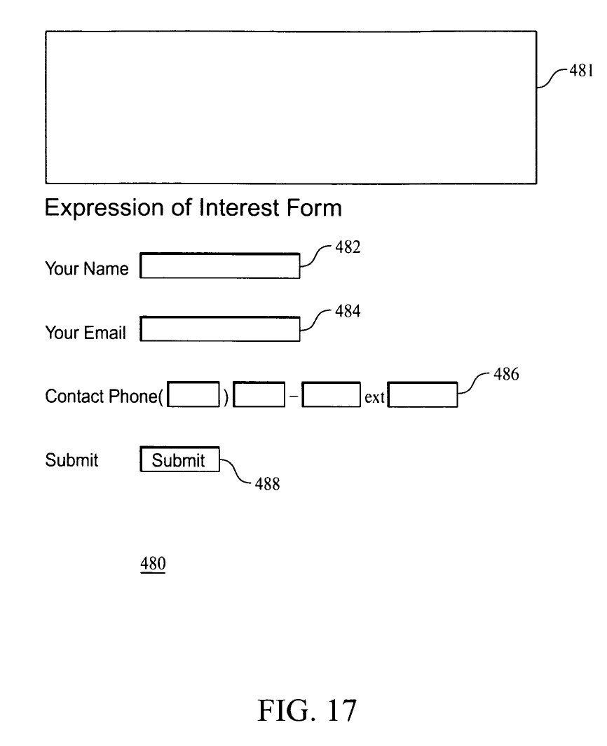

In step 310 the customer clicks on the “Submit Query” box which leads to the Query Form page, FIG. 17.

FIG. 17 is an embodiment internet Product Query Form page. The Page has the distributor's logo 481. In addition, there are spaces for the customer to fill in the customer's name 482, email address 484, and contact phone number 486. A “Submit” box 488 allows the customer to submit the information to the distributor by email.

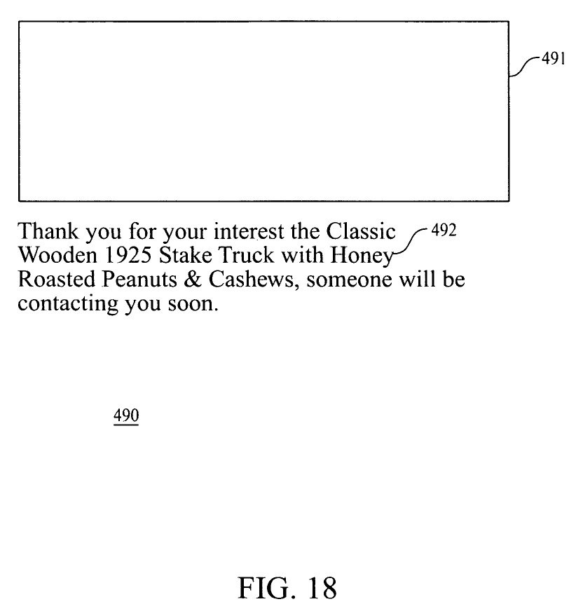

In step 310 the customer clicks on the “Submit” box which brings up a Query Confirmation page, FIG. 18.

FIG. 18 is an embodiment internet Product Query Confirmation Page 490. The page has a distributor's logo 491 and a statement 492 which confirms the receipt of the query by the distributor and indicates contact with the distributor will be forthcoming.

In step 314 the customer clicks on the featured product image 464 in FIG. 17 for more information on the supplier which brings up a Supplier Page, FIG. 19.

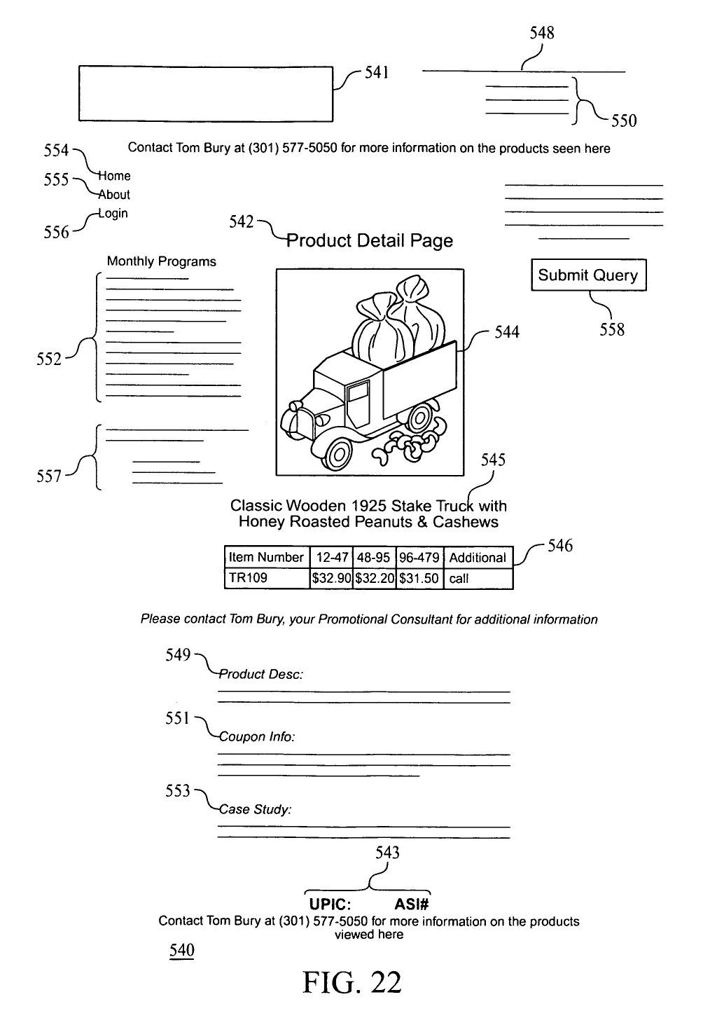

FIG. 19 is an embodiment internet Supplier Page 500. This page has the distributor logo 501, distributor name 508, and accessible information concerning the distributor 510, and inaccessible information 502 concerning the supplier such as the supplier's name. Clicking on “Home” 503 brings up the Calendar Manufacturer's Home Page (FIG. 13). Clicking on “About” 504 brings up additional information on the supplier. Clicking on “Login” 505 brings up an optional provision for registration of the site visitors. Arrayed along the side of the page is a list of the months and themes or programs 512. Clicking on any of the months listed leads to the appropriate Monthly Page. A forward looking reminder 517 reminds customers of the need to order products for use in upcoming months. The main feature of a Supplier Page 500 is the array of boxes 509, 511, 513, 514, 515, 516, 519-522, each of which contain a picture of the featured supplier's products along with the name of the product, for example the picture 507 and name 506 in box 509. Clicking on any of the boxes leads to the Product Detail Page (As in FIG. 22) for that product. More information concerning the products also can be obtained by requesting a catalog of the supplier's products by clicking on the “Submit Query” button 518. In addition, access to a video provided by the supplier is optional and not shown in FIG. 19.

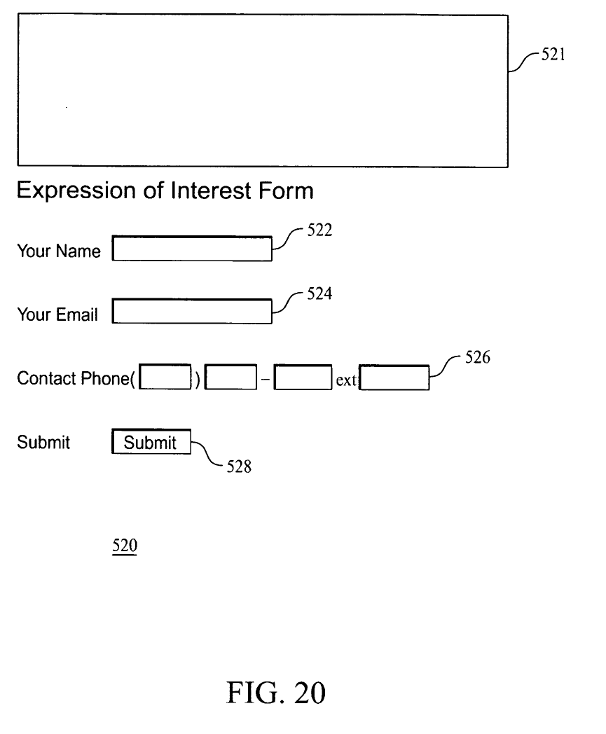

In step 316 the customer requests a catalog by clicking on the “Submit Query” button 518 in FIG. 19 which brings up a Catalog Request Form FIG. 20.

FIG. 20 is an embodiment internet Catalog Request Page 520. The Page has the distributor's logo 521. In addition, there are spaces for the customer to fill in the customer's name 522, email address 524, and contact phone number 526. A “Submit” box 528 allows the customer to submit the information to the distributor by email.

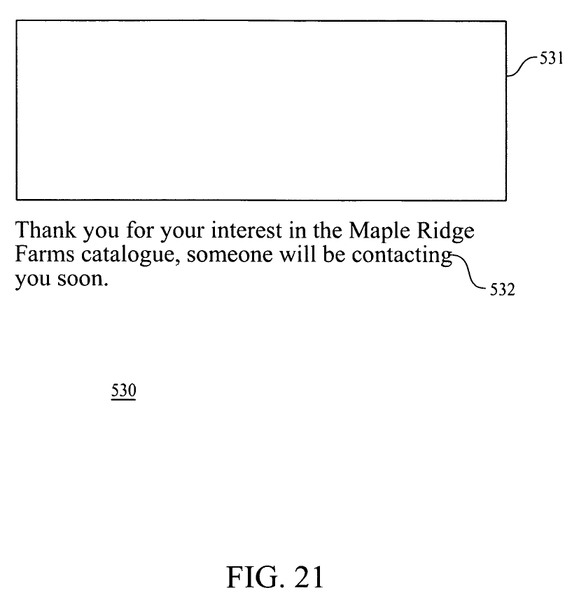

In step 318 the customer clicks on the “Submit” box 528 of FIG. 20 which brings up a Catalog Confirmation page, FIG. 21.

FIG. 21 is an embodiment internet Product Query Confirmation Page 530. The page has a distributor's logo 531 and a statement 532 which confirms the receipt of the query by the distributor and indicates contact with the distributor will be forthcoming.

In step 320 the customer clicks on a box in FIG. 19, for example, box 509 which brings up a Product Detail Page FIG. 22.

FIG. 22 is an embodiment internet Product Detail Page 540. The name of the page 542 along with name of the featured product 545 is listed along with a picture 544 of the featured product. Visible in FIG. 22 is the distributor logo 541, distributor name 548, and accessible information concerning the distributor 550. Clicking on “Home” 554 brings up the Calendar Manufacturer's Home Page (FIG. 13). Clicking on “About” 555 brings up additional information on the product. Clicking on “Login” 556 brings up an optional provision for registration of website visitors. A list of the months and themes or programs 552 is arrayed along one side of the page. Clicking on any of the months listed leads to the appropriate monthly page. A forward looking reminder 557 reminds customers of the need to order products for use in upcoming months. Inaccessible information 543 concerning the supplier, in this case, the supplier UPIC and ASI identifying numbers are listed. Pricing information 546 is included, along with additional product description 549, coupon information 551, if applicable, a case study 553 showing the successful application of the product in application of the program. To request a supplier's catalog the customer clicks a “Submit Query” box 558.

In step 322 the customer clicks on the “Submit Query” box 588 of FIG. 22 which brings up the Catalog Request Page FIG. 20.

In step 318 the customer fills out the information on the Catalog Request Page FIG. 20 (described in detail above) and clicks on the “Submit” button 528, FIG. 20, which emails the distributor and brings up the Catalog Confirmation Page FIG. 21. (described in detail above).

TABLE 1

| Month | Program | Benefits |
|---|---|---|
| January | Tradeshow | Invite prospects |
| | | Remind prospects |
| | | Reinforce message |
| February | Patron appreciation | Retain clients |
| | | Encourage loyalty |
| | | Increase revenues |
| March | Spring fashions- | Communication |
| | wearables | Consistency |
| | | Customization |
| April | Golf | Create goodwill |
| | | Networking opportunities |
| | | Public relations |
| May | Patriotism and loyalty | Improved employee morale |
| | | Increased productivity |
| | | Reduced absenteeism |
| June | Fundraising outdoor | Positive image |
| | Activities | Team spirit |
| | | Media exposure |
| July | Summer vacation | Confidence (reliability) |
| | | Stand out |
| | | Increase sales |
| August | End of summer programs | Build relationships |
| | | Energize staff |
| | | Increase visibility |
| September | Back to work | Team spirit |
| | | Lock in revenue |
| | | Share of mind |
| October | Safety and security | Reliability trustworthiness |
| | | Increase morale |
| | | Reduced insurance premiums |
| November | Recognition | Create goodwill |
| | | Strengthen internal relationships |
| | | Reduce attrition and turnovers |
| December | Holiday cheer | Networking |
| | | Give back - charity |
| | | Promote external relationships |

Table 1 lists the months of the year, representative themes or programs, 138 in FIG. 5), and representative benefits, (140 in FIG. 5) which stem from such programs used in embodiments of calendars of this disclosure. Other themes or programs and other benefits are contemplated.

### Table 2

### Planning Tools

### Return on Investment (ROI).

ROI quantifies the benefit of investing in a program. For example, if a safety program is implemented, the ROI would be the financial benefit of the program compared to the cost of the program. The ROI would be the present value of the benefits of the program (the insurance premiums before the program minus the premiums after the program) divided by the present value of the investment in the program. Return on Objectives (ROO)

ROO quantifies the benefit of acting to achieve an objective. The costs of programs to obtain objectives are relatively easy quantify but quantifying the results of the programs may be more difficult. For example, the objective is to save money by lowering insurance premiums. The program would be a Safety program. The ROO would be measured after completion of the program by comparing the number of insurance claims before the program with the number of insurance claims after the program. Other objectives, such as education of customers, enhancing standing in the industry, obtaining competitive date, and building relationships with current customers also can be quantified by using subjective judgments about the value of the results. The first step is to establish criteria—define the objectives, then weigh the objectives by assigning points on a scale, then measure the resulting ROO by dividing the resulting points by the costs required to achieve those points. Evaluation of Opportunity (EOO).

EOO is a qualitative evaluation of opportunities undertaken after the opportunity has passed. For example, suppose the opportunity was a trade show. The EOO analysis would ask questions such as: What was offered that we did or did not take advantage of? What should we do differently next time? What was our competition doing? Did they succeed?

Table 2 lists some planning tools as shown in FIG. 8 for use by the customer in planning a campaign using customized promotional products.

TABLE 3

| Month and Theme | Marketing Minutes |
|---|---|
| January - | Obtain a target list of prospects and clients |
| Work A Trade Show | Pre-mail invitation to visit booth |
| | Offer an incentive to visit booth |
| | Use promotional products the fits message |
| | Conduct follow up campaign |
| February - | Define goals: first order, most orders, loyalty |
| Gain Customer | Delivery: hand carry, mail, special courier |
| Appreciation | Creative and fun packaging |
| | Personalize promotional item or card |
| | Make offer for next order, 2 for 1 |
| March - | Select products right for customer |
| Wear Your Brand | Evaluate decorating options |
| or Image | Consider additional imprint areas |
| | Determine imprint areas |
| | Check samples for size and shrinkage |
| April - | Plan at least one year in advance |
| Run a Golf | Find a course in favorable location |
| Tournament | Assure affordability to the players |
| | Have plenty of advertising and marketing |
| | Obtain sponsorships |
| May - | Empathy. Show you care |
| Encourage Loyalty | Accomplishment. Show you appreciate it |
| | Training. Continuing education is valued |
| | Appreciation. Say “Thank You.” |
| | Communication. Say “What do you think?” |
| June - | Venue: appropriate, challenging, fun |
| Conduct Fund | Pre-mailing: “Save-the-Day” cards |
| Raiser | Plenty of advertising and marketing |
| | Registration: online and prepaid |
| | Promotional items as thank you gifts |
| July - | Tune up the vehicle |
| Have a Stress | Stop the mail and newspapers |
| Free Vacation | Light the house using timers |
| | Use Travel Checks |
| | Arrange a key person contact |
| August - | Define goals |
| Increase Employee | Create team atmosphere |
| Productivity | Reinforce goals with promotional products |
| | Have beef and squak sessions |
| | Solicit ideas for productivity improvement |
| | Reward achieving goals |
| September - | Develop and define goals |
| Keep Employees | Make goals brief, concise, realistic |
| Focused | Communicate goals to employees |
| | Accompany goals with promotional items |
| | Encourage feedback with a program |
| October - | Create Safety Awareness campaign |
| Improve Safety | Designate week or month for campaign |
| Awareness | Have clear and concise safety goals |
| | Reward accomplishment of goals |
| | Use promotional items to reinforce program |
| November - | Define objectives |
| Motivate | Reward specific actions |
| Employees | Personalize the reward |
| | Let the reward equal the desired action |
| | Use creative and fun packaging |
| December - | Send invitations 6-8 weeks in advance |
| Have a Holiday | Select appropriate venue |
| Party | Put someone in charge of music |
| | Offer a variety of food and beverages |
| | Give promotional items as take home gifts |

Table 3 lists some Marketing Minutes as shown at 154 in FIG. 5 for use by the customer in planning a campaign using customized promotional products.

TABLE 4

| Promotional | |
|---|---|
| Product | Slogan |
| Chocolates | “A “delicious” way to say: We Appreciate You” |
| Apple Clock | “Your thoughtful gesture of Appreciation will |
| | vault you to: “The head of the class”” |
| Compact Disc | “On the road or in the home this Vinyl Zippered |
| Holder | Compact Disc Holder Holds Our Sounds of |
| | Appreciation” |
| Stuffed Bear | “Without your generous time and efforts our |
| | project would have been “un-Bearable”” |
| Pin | “Those who give are such a sensation, we give |
| | this pin to show our Appreciation” |
| Pen | “We could not come up with the right words to |
| | express our deepest Appreciation, but if we could, |
| | here is the pen we would use” |
| Cup | “Our “Cut Runneth Over” with |
| | Appreciation” |

Table 4 lists some promotional products with suggested slogans as shown at 106 in FIG. 2 for use by the customer in planning a campaign using customized promotional products.

While a number of exemplary aspects and embodiments have been discussed above, those of skill in the art will recognize certain modifications, permutations, additions and subcombinations thereof. It is therefore intended that the following appended claims and claims hereafter introduced are interpreted to include all such modifications, permutations, additions and sub-combinations as are within their true spirit and scope.

I claim:

1. A calendar for dissemination by distributors of customized promotional products manufactured by suppliers to customers of such products comprising
a calendar with accessible information indicia on the calendar allowing access to the distributor by the customer,
a distributor specific URL indicia bearing distinctive identification indicia concerning the distributor,
the URL indicia for a password protected website homepage bearing distinctive identification indicia concerning the distributor,
the website further comprising a multiplicity of supplier advertising pages bearing information indicia concerning customized promotional products,
each website supplier advertising page free of accessible information indicia allowing contact between customers and suppliers,
each website supplier advertising page bearing identifying symbol indicia allowing identification of the supplier by the distributor,
wherein a multiplicity of distributor specific website homepages lead to the same supplier advertising pages.

2. The calendar of claim 1 further comprising a theme or program associated with each month and advertisements for promotional products that can be customized to reinforce each theme or program, each advertisement free of accessible information indicia allowing contact between suppliers and customers, and each advertisement bearing identifying symbol indicia allowing identification of the supplier by the distributor.

3. The calendar of claim 2 further comprising indicia consisting of a list of te benefits to the customer associated with implementing the theme or program of the month.

4. The calendar of claim 2 further comprising indicia consisting of at least one case study of a customer who implemented the theme or program of the month and reaped the benefits thereof.

5. The calendar of claim 2 further comprising indicia consisting of statistics showing the advantages associated with implementation of the theme or program of the month by the customer.

6. The calendar of claim 2 further comprising indicia consisting of slogans for printing on the promotional product for use by a customer in implementation of the theme or program of the month in connection with the promotional products or associated packaging.

7. The calendar of claim 2 further comprising a photograph of a customizable promotional product of sentimental value to a customer and explanation of the importance of the product shown.

8. The calendar of claim 2 further comprising tips on the implementation of the theme or program to insure maximum benefit to the customer.

9. The calendar of claim 2 further comprising indicia consisting of reminders of deadlines for ordering customized promotional products which fall in subsequent months.

10. The calendar of claim 2 further comprising a work sheet for use of a customer in planning the customer's campaign using customized promotional products.

11. The calendar of claim 2 further comprising a tear-off work sheet page with indicia for use by a distributor in planning the customer's campaign using customized promotional products and on the opposite side indicia consisting of marketing evaluation questions for use of the distributor in planning the customer's campaign.

12. The calendar of claim 2 further comprising a page with indicia consisting of description of return on investment, return on objective, and evaluation of opportunities, miniature two year calendars, and symbols or colors representing the 12 themes or programs of the current year.

13. The calendar of claim 2 wherein each month is associated with a different color.

14. The process of selecting, ordering, and manufacturing customized promotional products for customers by distributors and suppliers comprising the steps:
a. providing a customer with a calendar bearing the distributor's website address by a distributor,
b. accessing the distributor's website by the customer using the distributor's website address,
c. perusing the product's on supplier advertising pages free of accessible information allowing contact between customers and suppliers by customer,
d. ordering selected customized promotional products from the distributor by the customer using identifying symbols allowing identification of the supplier by the distributor,
e. ordering the selected customized promotional products from the suppliers by the distributor,
f. manufacturing the selected customized promotional products by the supplier, and
g. providing the customer the selected customized promotional products.

15. The process of claim 14 further comprising the step following step d.:
d′. paying the distributor for the customized promotional products by the customer.

16. The process of claim 14 further comprising the step following step d.:
d″. paying the supplier for the customized promotional products by the distributor,

17. The process of claim 14 wherein step g. further comprises the step:
g′. shipping the selected customized promotional products directly to the customer by the supplier.

18. The process of claim 14 wherein step g. further comprises the steps:
g″. shipping the selected customized promotional products to the distributor by the supplier and
g′″. shipping the selected customized promotional products to the customer by the distributor.

19. The process of claim 18 further comprising the step between step g″ and step g′″:
g′″. auditing the customized promotional products by the distributor.

20. The process of claim 14 further comprising the step following step d.:
d′. auditing the customer's order for customized promotional products by the distributor.
